(19) United States
(12) Patent Application Publication
(10) Pub. No.: US 2004/0021430 A1
(43) Pub. Date: Feb. 5, 2004

(54) Method and device for controlling luminous units in an optical monitoring system

(76) Inventors: Klaus-Peter Linzmaier, Winterbach (DE); Roland Stuetzer, Lorsch (DE)

Correspondence Address: HARNESS, DICKEY & PIERCE, P.L.C., P.O.BOX 8910, RESTON, VA, 20195, US

(21) Appl. No.: 10/297,410

(22) PCT Filed: May 28, 2001
(86) PCT No.: PCT/DE01/02017

(30) Foreign Application Priority Data
Jun. 7, 2000 (DE) 100 28 141.9

(51) Int. Cl. H05B 37/00

(52) U.S. Cl. 315/291; 315/247; 315/312

(57) ABSTRACT

The luminous units in an optical monitoring system, especially in the placement and treatment of electronic components, are controlled via flash impulses (FI), the parameters of which, namely intensity and duration, are stored in digital form. The flash impulses are generated on the basis of these digital values by pulse width modulation. The invention thereby allows to simply adapt and modify the parameters of certain luminous elements or of certain machine requirements in the software without requiring a manual adjustment of the pulse circuit.

The invention relates to a method for driving luminous units each having at least one luminous element for the purpose of flash illumination in an optical monitoring system, in particular in the positioning of electrical and/or electronic components and/or assemblies in a processing machine, the luminous units being driven with a flash pulse of predetermined intensity and duration in each case when a request signal arrives. Furthermore, the invention relates to a device for carrying out this method.

An example of a typical area of application for the invention is the automatic population of printed circuit boards or other substrates with electrical components, it being necessary to determine the position of the components relative to the placement position. Another important case of use is the processing of electrical components by means of laser beams, the point at which the laser beam impinges on the component to be processed having to be positioned exactly. In these processes, so-called vision systems comprising a camera, for example a CCD camera, and an illumination device are used for position identification purposes. In this case, the camera passes a request signal to the illumination device, which thereupon drives the luminous units with a flash pulse, so that the camera can record an optimum image. In order to generate enough light for the optimum optical measurement in this case, the diodes that are normally used as luminous elements are overdriven with a current which is up to five times higher than the nominal current.

In conventional installations, the illumination diodes have been driven via digital/analog converters in which case the drive circuits have in each case been designed for the concrete case of application and, moreover, have also had to be adapted to the diodes used, for the compensation of component variations, by means of trimming potentiometers. The aging of the components, too, has been able to be taken into account only by means of manual readjustment.

U.S. Pat. No. 5,469,294 A has also already discussed the possibility of selecting the intensity of the illumination by means of corresponding drive commands, so that after a basic setting mechanical adaptation ought no longer to be necessary. However, in that case, too, the basic setting of the values for a specific machine must be performed manually by individual adaptation.

It is an aim of the invention to provide a method and an apparatus for driving luminous units of the type mentioned in the introduction, there being no need whatsoever for mechanical adaptation of the pulse generation to a specific machine or to specific properties of the luminous elements.

This aim is achieved according to the invention, in the case of a method of the type mentioned in the introduction, by virtue of the fact that the values for the intensity and the duration of the flash pulse are defined in digital form in a parameter memory and are output via a data line to a pulse generating device, which generates the flash pulse according to intensity and duration by modulation and outputs it subsequent to the request signal.

Preferably, the flash pulse is generated by pulse width modulation as a sequence of individual pulses whose mark/space ratio determines the intensity of the flash pulse.

Thus, in the case of the invention, the intensity of the illumination flash is not defined by hardware, but rather is stored in the form of digital values. These stored values then pass to the pulse generating device, preferably a pulse width modulator, which then generates the desired flash pulses. The pulse generating device is not individually matched to a specific device or to specific diode properties, but rather can generate the flash pulses in accordance with the required parameters. As a result, it is also possible to adapt the generation of the flash pulses to new requirements in a simple manner by changing the stored parameters. An adaptation to tolerances of the luminous elements, that is to say the diodes, can be realized by means of an automatic calibration routine in which the light intensity is measured, so that, in the event of a deviation from a desired value, a correction calculation can be carried out and new parameters for driving the pulse generating device can be obtained therefrom. Such a calibration measurement will generally be made during the start-up, in order to adapt the values to the luminous elements used. However, it can also be repeated at specific time intervals in order, by way of example, to compensate for aging of the light-emitting diodes.

If luminous elements, such as light-emitting diodes, are overdriven, they are permitted to be operated only within specific limits. Therefore, in a preferred refinement of the invention, it is provided that the mark/space ratio of the luminous units is monitored and that a minimum pause time is prescribed after each flash pulse in order to prevent thermal destruction of the luminous elements. The minimum pause duration can be defined in a manner dependent on the properties of the luminous elements and on the intensity and the duration of the flash pulses. Any incoming request signal is supressed in this minimum pause time.

In addition, it may be provided that instead of being driven with flash pulses, the luminous units are driven with a continuous light intensity which corresponds at most to the nominal value or to the continuous loadability of the luminous elements.

A device for carrying out the method according to the invention has a parameter memory, in which values for the intensity and the duration of the flash pulse are stored in digital form, and a pulse generating device, to which the values stored in the parameter memory are fed via a data bus, which furthermore has an input for a request signal and which finally has flash pulse outputs each connected to a luminous unit.

In addition, in one development, the device has a calibration device with a light measuring device and a comparison device, which is able to measure, as required and/or after specific time intervals, the light intensity of the luminous units for specific parameters of the flash pulses, to compare it with stored desired values and, in the event of deviations, to carry out a change in the values in the parameter memory.

The invention is explained in more detail below using an exemplary embodiment with reference to the drawing, in which

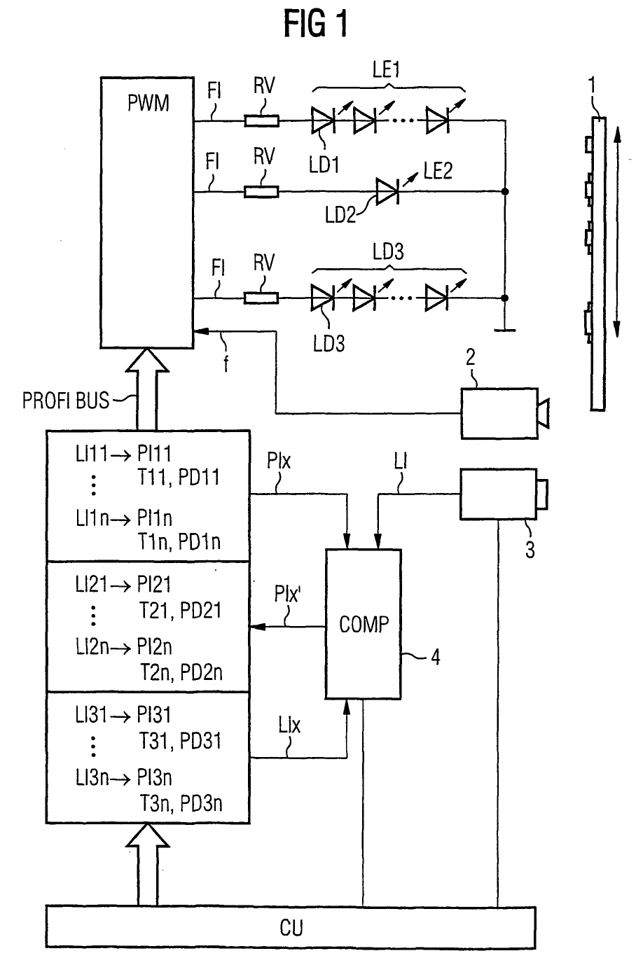

FIG. 1 shows an illumination device which is controlled according to the invention, in a block illustration,

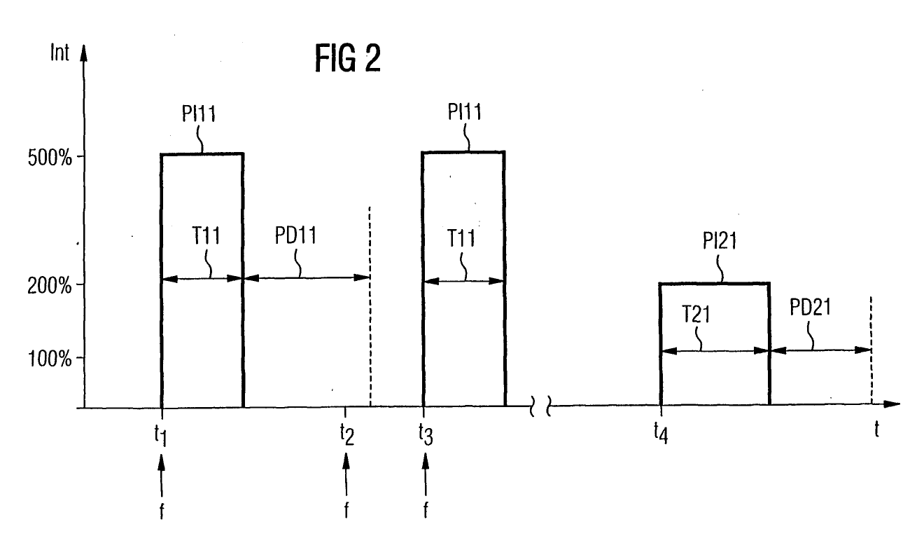

FIG. 2 shows a timing diagram illustrating the intensity for the driving of the luminous units with flash pulses, and

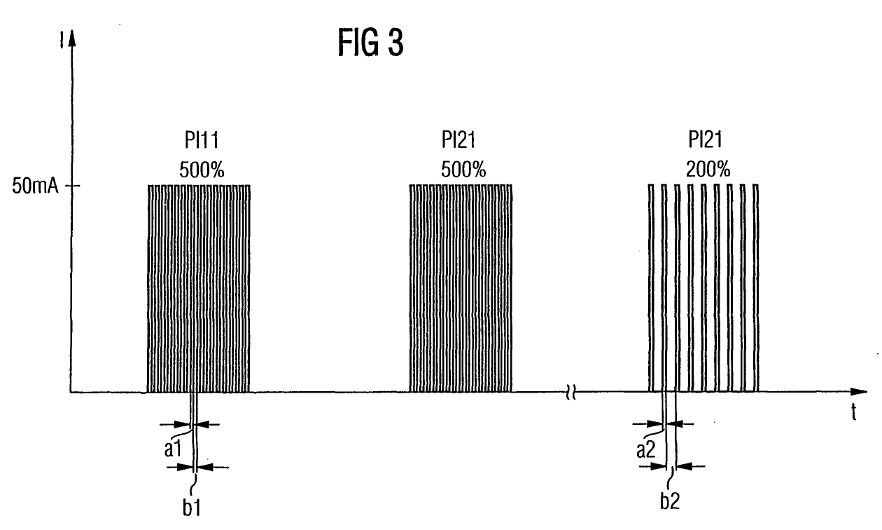

FIG. 3 shows a timing diagram illustrating the current profile during the driving of the luminous units with different intensities.

FIG. 1 diagrammatically shows the arrangement of an illumination device in an optical monitoring system. A printed circuit board 1 with components that are arranged or are to be arranged thereon is shown diagrammatically, which printed circuit board can be displaced toward different sides and the position of which printed circuit board is to be accurately measured in order to arrange specific components exactly on it or to process them by laser drilling, laser structuring or laser trimming and the like. For this purpose, the printed circuit board or another object is recorded by a camera 2 at specific points in time, specific marking points (not illustrated in any further detail) on the printed circuit board 1 being measured. However, in order to obtain a sharp image with the camera 2, which is a CCD camera, for example, the object, namely the printed circuit board 1, is illuminated with flash pulses at specific recording times. Luminous units LE1, LE2 and LE3 are used for this purpose, which, in the example, each comprise a specific number of light-emitting diodes LD1 and LD3, respectively, or else only a single light-emitting diode LD2. It would be conceivable, however, also to use other luminous elements. The light-emitting diodes of the various luminous units may be designed for example for light of different wavelengths in order to bring about different light effects for instance by turning on the luminous units LE1, LE2 or LE3. Instead of light-emitting diodes, however, it is also conceivable to use other luminous elements.

For an accurate recording, the camera 2 uses a request signal f to request a flash pulse FI for one or more of the luminous units LE1 to LE3. The flash pulse is generated in a pulse width modulator PWM individually for each luminous unit and passed to the relevant luminous unit via a respective series resistor RV. The current intensity is defined in each case via the series resistor RV; the light intensity is proportional to the current in accordance with the characteristic values of the light-emitting diodes.

The intensity and pulse duration of the respective flash pulses FI is defined in a parameter memory PSP individually for each luminous unit, to be precise in accordance with the respectively desired light intensity LI which is intended to illuminate the object. Thus, the following are defined in the parameter memory PSP: light intensities LI11, LI12, . . . to LI1n, for the luminous unit LE1, light intensities LI21, LI22 etc. to LI2n for the luminous unit LE2 and the associated light intensities LI31, LI32 to LI3n etc. for the luminous unit LE3. In this case for each light intensity LI, an associated pulse intensity PI for the flash pulse to be generated is stored in accordance with the properties of the luminous elements, that is to say the light-emitting diodes. Thus, by way of example, a pulse intensity PI11 corresponds to a light intensity LI11, a pulse intensity PI12 corresponds to a light intensity LI12, and a pulse intensity PI3n corresponds to a light intensity LI3n. This assignment is determined empirically when setting up the installation and is stored in the parameter memory. In addition, each flash pulse is assigned a pulse duration, for example T11, T12, etc. Since the luminous elements or light-emitting diodes are overdriven in the event of the respective flash pulse, they require a certain cooling time after each pulse, depending on the intensity and duration of the pulse. Therefore, in addition to the pulse parameters, a respective minimum pause duration PD is also stored in the parameter memory PSP, which minimum pause duration is concomitantly passed to the pulse width modulator PWM and suppresses the generation of a further flash pulse FI for the duration of the pulse pause.

By means of a central control unit CU, the pulse parameters for the respective luminous units LE1 to LE3 are selected and passed to the pulse width modulator PWM via a data bus, for example a PROFIBUS that is present anyway. At said pulse width modulator, as mentioned, the respective flash pulse FI is then triggered by the request signal f.

As described, the parameters for the flash pulses are stored in the parameter memory in accordance with the desired light intensity and the properties of the luminous elements. The assignment of the parameters to specific light intensities is defined by a calibration measurement during start-up, but can also be repeated later at specific intervals or as selected, in order, by way of example, to take account of the aging of the light elements. For this purpose, a calibration device, comprising a light measuring device 3 and a comparison device 4, is provided in the example illustrated, with which device, after driving by the central control unit CU, the actual light intensity LI for selected flash pulses PIx is compared with the stored light intensity LIx. If a deviation between the measured light intensity and the stored light intensity LIx is ascertained in the comparison device 4, this leads to a correction of the intensity value; thus, instead of PIx, a value PIx′ is stored and used for future flash pulses.

The profile of flash pulses is illustrated by way of example in a diagram in FIG. 2. The pulse intensity Int is plotted against time t. Thus, by way of example, an intensity of 100% signifies the driving of the light-emitting diodes with a continuous light intensity which corresponds to the continuous loadability. Such continuous illumination, which is not shown here, could be set instead of the flash illumination. In accordance with the illustration in FIG. 2, a flash pulse FI is generated at the instant t1, which flash pulse has an intensity PI11 of 500% in the example, that is to say effects overdriving of the luminous elements to five times their continuous loadability. The flash pulse itself has a pulse duration T11; afterward, the intensity returns to 0% again.

Owing to the overdriving, however, the luminous elements LE require a recovery time; the latter is defined by the minimum pause duration PD11 in accordance with the pulse intensity and the pulse duration. By way of example, if a further request signal f arrived during said minimum pause duration, that is to say at the instant t2, for example, then no flash pulse would be generated in the pulse width modulator PWM. Only if a request signal f arrives again after the pause duration PD11 has elapsed, at the instant t3 in FIG. 2, is a flash pulse having the intensity PI11 and the duration T11 generated again and passed to the luminous unit LE1.

FIG. 2 furthermore shows the possibility that a different light intensity is set, so that a flash pulse having the intensity PI12 is generated at an instant t4, which flash pulse effects an overdriving of only 200% and has a pulse duration of T21, for example. A different minimum pause duration PD21 is then defined in accordance with this intensity and pulse duration. This changeover can be effected by means of simple selection in the parameter memory, without having to change the pulse width modulator PWM or an arrangement hardwired in some other way.

FIG. 3 shows the generation of the pulse intensities by the pulse width modulator in a further diagram against time. In this case, the current intensity is plotted against time t, said current intensity being defined once at a specific value, at 50 mA in the example, through the dimensioning of the diode circuit and not being altered. With this current intensity that is set once, the pulse width modulator PWM generates the different intensities of the flash pulses by changing the mark/space ratio of a sequence of individual pulses which together produce the flash pulse having the predetermined intensity. Thus, if the intention is to generate a flash pulse with overdriving of 500%, then the pulse width modulator PWM generates individual pulses having a mark width of al and a space width of b1, while a ratio of mark width a2 and space width b2 is generated in order to generate an intensity of 200%.

By generating the intensity by means of pulse width modulation with the current intensity always having the same magnitude and by storing the pulse parameters in digital form in the parameter memory PSP, it is possible to effect changes and adaptations of the light intensity to new conditions solely by changing the software, without a change in the wiring or some other adjusting apparatus in the hardware.

1. Method for driving luminous units (LE1, LE2, LE3) each having at least one luminous element (LD1, LD2; LD3) for the purpose of flash illumination in an optical monitoring system, in particular in the positioning of electrical and/or electronic components and/or assemblies in a processing machine, the luminous units (LE1, LE2, LE3) being driven with a flash pulse (FI) of predetermined intensity and duration in each case when a request signal (f) arrives, characterized in that the values for the intensity (PI11, PI12 . . . PI1n) and the duration (T11, T12 . . . ) of the flash pulse (FI) are defined in digital form in a parameter memory (PSP) and are output via a data line to a pulse generating device (PWM), which generates the flash pulse (FI) according to intensity and duration by modulation and outputs it subsequent to the request signal (f).

2. The method as claimed in claim 1, characterized in that the flash pulse (FI) is generated by pulse width modulation as a sequence of individual pulses whose mark/space ratio (a1/b1; a2/b2) determines the intensity of the flash pulse.

3. The method as claimed in claim 1 or 2, characterized in that the luminous elements (LD1, LD2, LD3) experience an overdriving as a result of the flash pulse (FI), said overdriving corresponding to a multiple of the permissible intensity for continuous loading of the luminous elements, and in that the driving is inhibited after each flash pulse (FI) for a minimum/pause duration (PD) defined in the parameter memory.

4. The method as claimed in claim 3, characterized in that the minimum pause duration (PD) is defined for each luminous unit (LEI, LE2, LE3) digitally in a manner dependent on the type and the properties of the luminous elements (LD1, LD2, LD3) and/or on the intensity (PI) and duration of the flash pulses (FI).

5. The method as claimed in claim 1, characterized in that, instead of being driven with flash pulses (FI), the luminous units (LE1, LE2, LE3) are driven with a continuous light intensity which corresponds at most to the continuous loadability of the luminous elements.

6. The method as claimed in one of claims 1 to 4, characterized in that the parameter values (PI11 . . . ) of the flash pulse which are required for a predetermined light intensity are determined for each luminous unit (LE1, LE2, LE3) by means of a calibration measurement and are stored in the parameter memory (PSP).

7. The method as claimed in one of claims 1 to 6, characterized in that the minimum pause duration (PD) is defined for each luminous unit (LE1, LE2, LE3) for in each case specific intensities (PI) of the flash pulse (FI) in tabular fashion.

8. A device for driving luminous units (LE1, LE2, LE3) each having at least one luminous element (LD1, LD2, LD3) for the purpose of flash illumination in an optical monitoring system, in particular in the positioning of electrical and/or electronic components and/or assemblies in a processing machine, the luminous units (LE1, LE2, LE3) being driven with a flash pulse (FI) of predetermined intensity (PI) and duration (T) in each case when a request signal (f) arrives, as claimed in one of claims 1 to 7, characterized in that a parameter memory (PSP) is provided, in which values for the intensity (PI) and the duration (PD) of the flash pulse (FI) are stored in digital form, in that a pulse generating device (PWM) is provided, to which the values stored in the parameter memory (PSP) are fed via a data bus (Profibus), which furthermore has an input for a request signal (f) and which has pulse outputs each connected to a luminous unit (LE1, LE2, LE3).

9. The device as claimed in claim 8, characterized in that the luminous elements are light-emitting diodes (LD1, LD2, LD3).

10. The device as claimed in either of claims 8 and 9, characterized in that a calibration device with a light measuring device (3) and a comparison device (4) is provided, which is able to measure, as required and/or after specific time intervals, the light intensity of the luminous units (LE1, LE2, LE3) for specific parameters (PIx) of the flash pulses (FI), to compare it with stored desired values (LIx) and, in the event of deviations, to carry out a change in the values in the parameter memory.
